(19) United States
(12) Patent Application Publication
(10) Pub. No.: US 2011/0265713 A1
(43) Pub. Date: Nov. 3, 2011

(54) Finishing Element of a Coating for a Typographic Cylinder and Manufacturing and Finishing Method Thereof, Coating of a Typographic Cylinder and Manufacturing Method Thereof, Typographic Cylinder Comprising Such a Coating, and Method of Application of Such a Coating to the Typographic Cylinder

(75) Inventor: Fausto Zeni, Lodi (IT)

(73) Assignee: TRELLEBORG ENGINEERED SYSTEMS ITALY S.P.A., Lodi Vecchio (Lodi) (IT)

(21) Appl. No.: 13/126,718

(22) PCT Filed: Oct. 29, 2009
(86) PCT No.: PCT/IT2009/000490

§ 371 Date: Jul. 14, 2011

(30) Foreign Application Priority Data
Nov. 3, 2008 (IT) MI2008A001929
Nov. 3, 2008 (IT) MI2008A001930
Nov. 3, 2008 (IT) MI2008A001931

(51) Int. Cl. B44C 3/12; B05C 1/04

(52) U.S. Cl. 118/200; 156/63

(57) ABSTRACT

In a typographic plate cylinder comprising a groove or gap (11) for assembly of a coating, which in turn comprises two flaps (211 and 211′), which, when bent and inserted into a groove or gap of the cylinder, form a gap in the coating; a completion element is provided comprising an elongated element (23) designed to be inserted and remain jammed in the gap, without projecting radially from the coating, so occluding the gap.

The present invention relates to an element for completing a coating for a typographic plate cylinder and corresponding production and completion method, to a coating for a typographic plate cylinder and corresponding production method, to a typographic plate cylinder that comprises said coating, and to a method for application of said coating on the typographic plate cylinder.

Machines for typographic printing are formed by different cylinders, some of which are limited to performing a driving function in regard to the paper that is passing, others regard, in particular, the printing process. Amongst the latter, at least one performs the function of picking up the ink from the printing matrix and transferring it to the paper. The coating (offset blanket) must guarantee a certain degree of compressibility to enable efficient pick-up of the ink from the printing matrix with a consequent improvement in the printing quality.

When the coating deteriorates, it is removed from the cylinder and replaced by a new coating.

For said purpose, the cylinder comprises a groove or gap, which runs longitudinally throughout the length of the cylinder, within which the flaps of the coating are inserted in order to be withheld.

The coating is formed by different layers, of which the first can be hard, and the others soft.

The hard layer is normally made of metal, whilst the soft ones may be made of fabric and/or elastomers.

In the soft layers, in some cases, layers of fabric are alternated with layers of elastomers. Said solution bestows the right degree of compressibility on the coating in relation to the number of alternating layers and thicknesses.

In a position corresponding to the groove or gap in the cylinder, where the flaps of the coating are inserted, a gap is formed on the coating.

Said groove or gap in the cylinder is normally not radial with respect to a cross section of the cylinder, but rather bent towards the edge leads in rotation (“leading edge”), the “trailing edge” being defined as the one opposed to the leading edge.

Generally, the flaps of the hard metal layer that is to be inserted in said groove or gap are not completely covered by the top layers precisely in order to facilitate insertion of said flaps into the groove or gap in the cylinder, in a position corresponding to which a gap is formed in the coating between the facing edges of the top layers of the coating itself.

Furthermore, in said gap, undesirable material accumulates on the coating, principally during the step of washing of the blanket, where the cleaning system can push said material into the gap itself. Said material can comprise paper dust mixed to ink and fountain liquid.

During the periods in which the typographic machine is not being used, the dust mixed with ink dries, loses adherence with the gap and comes out of it, risking dispersion over the surface of the coating of the typographic plate cylinder and so damaging it. There thus arises the technical problem of filling said gap in the coating of the typographic plate cylinder in order to eliminate the problem of accumulation of undesirable material in a simple and inexpensive way.

The purpose of the present invention is to provide an element for completing a coating for a typographic plate cylinder and corresponding production and completion method, a coating for a typographic plate cylinder and corresponding production method, a typographic plate cylinder that comprises said coating, and a method for application of said coating to the typographic plate cylinder that will overcome the drawbacks presented by the known art.

Forming a particular subject of the present invention is an element for completing a coating for a typographic plate cylinder, as well as a corresponding production and completion method, a coating for a typographic plate cylinder and the corresponding production method, a typographic plate cylinder that comprises said coating, and a method for application of said coating on the typographic plate cylinder, as defined in the claims, which form an integral part of the present description.

Further characteristics and advantages of the invention will emerge more clearly in the light of the detailed description of preferred, but non-exclusive, embodiments of an element for completing a coating for a typographic plate cylinder and corresponding production and completion method, a coating for a typographic plate cylinder and corresponding production method, a typographic plate cylinder that comprises said coating, and a method for application of said coating on the typographic plate cylinder, illustrated by way of non-limiting example, with the aid of the annexed plates of drawings, in which:

FIG. 1 shows a cross section of a typographic plate cylinder with, in evidence, a groove or gap for assembly of the coating thereon;

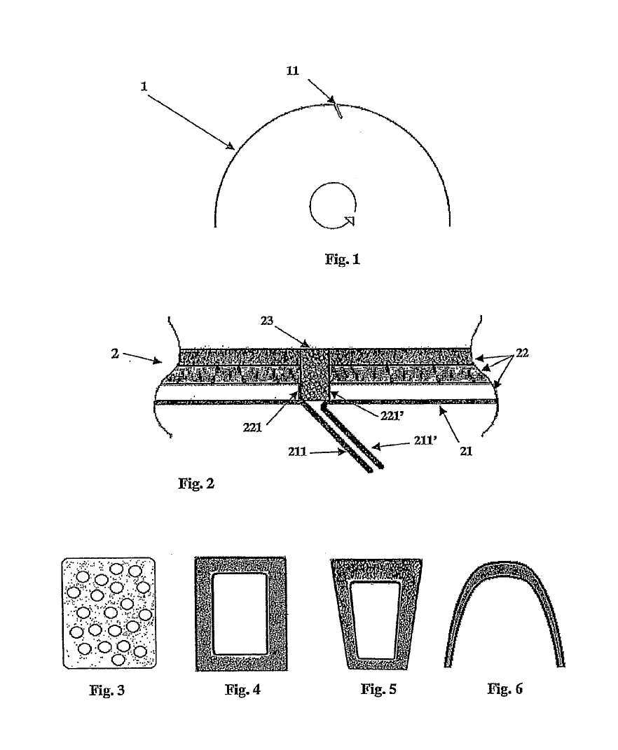

FIG. 2 shows a cross section of the coating in a position corresponding to the gap after assembly on the typographic plate cylinder, with a completion element inserted according to a first variant thereof;

FIG. 3 shows a cross section of a second variant of the completion element;

FIG. 4 shows a cross section of a third variant of the completion element incorporating an internal cavity;

FIG. 5 shows an embodiment of a fourth variant of the completion element with trapezial cross section;

FIG. 6 shows an embodiment of a fifth variant of the completion element with open cross section;

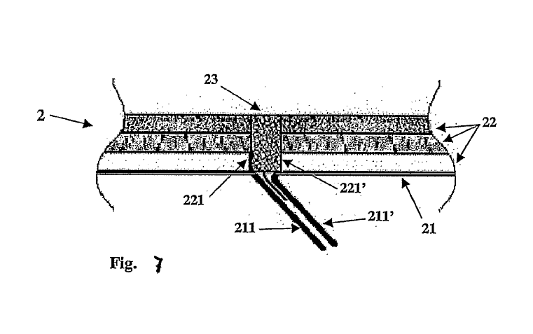

FIG. 7 shows a cross section of the coating in a position corresponding to the gap after assembly on the typographic plate cylinder, with the completion element with appendage according to a sixth variant thereof inserted;

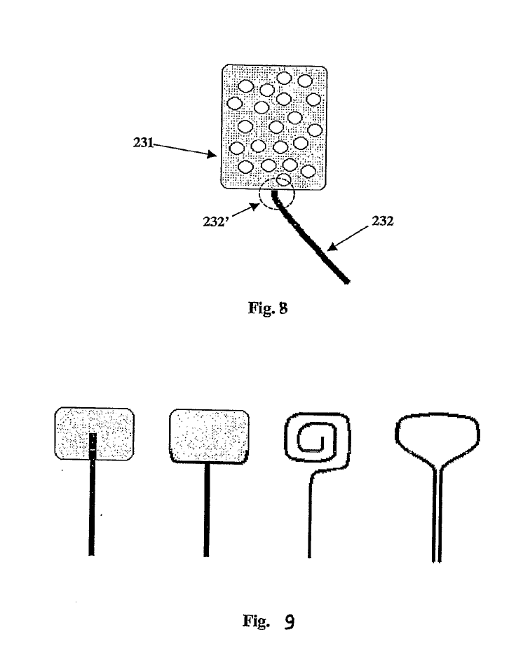

FIG. 8 shows a cross section of the element with the appendage of the preceding figure;

FIG. 9 shows a seventh, an eighth, a ninth, and a tenth variant embodiment of the completion element;

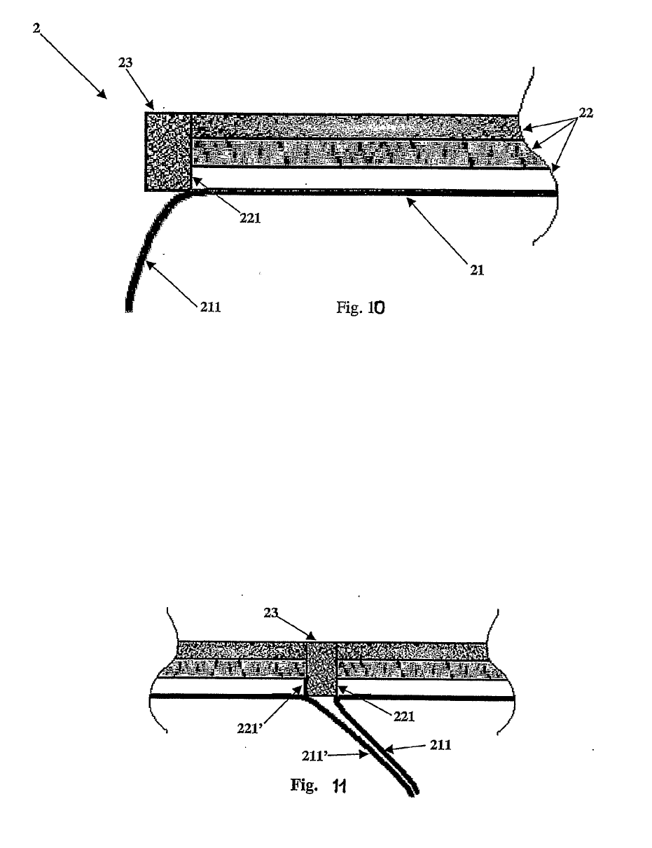

FIG. 10 illustrates a cross section of a flap for coating typographic plate cylinders according to a further preferred embodiment; and

FIG. 11 represents a cross section of just the coating of FIG. 10 in a position corresponding to the gap after assembly on the typographic plate cylinder.

The same reference numbers and letters in the figures identify the same elements or components.

With reference to FIGS. 2 to 6, the coating 2 comprises a hard layer 21, applied on which are a number of soft layers 22.

Assembly of the coating 2 on the typographic plate cylinder 1 envisages bending of the flaps 211 and 211′ of the hard layer 21, and their insertion in the slit 11 (gap in the cylinder) that runs longitudinally on the lateral surface of the typographic plate cylinder 1. In this way, a gap is formed on the coating, between its two opposed edges 221 and 221′.

According to the present invention, the completion of the coating 2 for the typographic plate cylinder 1 comprises insertion of a completion element, i.e., an elongated element 23 (gap filler), in the gap that it is formed in the coating 2, between the edges 221 and 221′ of the layers of soft material 22.

The advantage of said solution is that of not stiffening further the area of the gap with the harmful use of adhesive, especially because dosing thereof is not easy to control and any even very slight smear would prove harmful for the purposes pursued.

Said elongated element or gap filler 23, instead, has an appropriate shape and is made of a compressible material so as to remain jammed in the gap once inserted. Furthermore, given that it is produced separately, it guarantees a shape such as not to project beyond the lateral surface of the coating in order to prevent any harmful impact for the paper processed during printing. Said gap filler 23 can be formed with a sealant, for example of the same type as the one used for sealing the opposed edges 221 and/or 221′ defined by the thickness of the layers of material 22 that belong to the coating on top of the hard layer 21. Said sealant can be appropriately injected into a mould and dried.

The gap filler 23 has a length such as to occlude at least a portion of the gap, preferably its entire extension. It may be made of elastomeric material comprising microspheres and/or cavities, or else be obtained with an appropriate geometry, such as to render it particularly compressible and hence possibly remain jammed in the gap. Its cross section is preferentially rectangular, as in FIGS. 3 and 4, but it may also have a trapezial cross section, as in FIG. 5, or else a triangular or circular cross section (not illustrated). It may also be obtained with an open cross section, as in FIG. 6, such as to enable a temporary deformation of the gap filler itself once inserted in the gap.

Said element can be obtained by extrusion or by moulding. Advantageously, insertion by pressure of said element prevents accumulation of ink and paper dust within the gap.

With reference now to FIGS. 7 to 9, the method of assembly of a coating for a typographic plate cylinder 1 comprises a step in which an elongated completion element or gap filler 23 is provided and is inserted between the opposed edges 221 or 221′ formed by the thickness of the top layers 22 of the coating 2.

Said two opposed edges 221 and 221′ face one another, forming the aforesaid gap when the coating is mounted and wound around the typographic plate cylinder.

In particular, during assembly, the flaps 211 and 211′ of the hard layer 21 are bent and inserted in the groove or gap 11.

Said gap filler 23 comprises, viewed in cross section with reference to FIG. 8, a compact region 231 and an appendage 232, which in turn comprises a crest area 232′ that is joined to the compact region.

Following upon or simultaneously with assembly of the coating on the typographic plate cylinder, said gap filler 23 is inserted in the gap 11 so that the compact region will occlude the gap, whilst the appendage 232, jammed in more deeply, functions as a stay, preventing the compact region from detaching from the gap.

In this way, the gap remains occluded by the gap filler 23 in at least one portion of its extension, preferably throughout its extension, preventing any intrusion of foreign bodies, such as ink and paper dust.

The cross section of the compact region 231 of said gap filler may be rectangular, trapezial, shaped like a portion of cylindrical cap, but may also have different shapes.

Furthermore, said compact region of the gap filler is constituted preferentially by elastomeric material and/or material containing appropriate cavities or microspheres that render it compressible, but may also be rigid and made of polymeric material, such as for example polyester, polyamide, or polyurethane. The appendage may be made of the same material as the compact region or else may be made of metal, for example aluminium or steel and in any case a material having mechanical characteristics suitable for the particular use.

The production of the gap filler can be obtained by moulding of the compact region on a crest portion 232′ of the appendage, or else by extrusion on the crest portion of the appendage, so that said crest portion remains embedded in the compact region. Both of these methods obtain the result of providing cohesion between the crest and the compact region.

Variant embodiments illustrated in particular in FIG. 9 envisage that, to render more effective cohesion between said parts, said crest, for a part englobed in the compact region, is T-shaped or else L-shaped, or else shaped like a V set upside down, or else may be a lamina comprising through openings, within which the material of which the compact region is formed during production of the gap filler may possibly penetrate.

A further embodiment of the invention envisages that the gap filler is made entirely of the same material and comprises a lamina bent so as to form both said appendage 232 and said compact region 231. According to this further embodiment, said bending can be spiral-shaped in order to bestow on the gap filler the necessary elasticity required during its insertion in the gap.

According to another aspect of the invention, the insertion of the gap filler within the gap can be subsequent to or simultaneous with assembly of the coating on the typographic plate cylinder.

In particular, if it is inserted simultaneously, said appendage is squeezed and drawn along by said flaps 211 and 211′.

In this case, it may be envisaged that the end of the appendage opposite to the one embedded in the compact region of the gap filler has a slight thickening or else a tooth. Furthermore, said tooth can be positioned so as to work on the edge of at least one of the flaps 211 and 211′ so that removal of the gap filler cannot be simultaneous with replacement of the coating.

With reference now to FIGS. 10 and 11, the method for producing a coating for the typographic plate cylinder 1 comprises a step in which an elongated completion element or gap filler 23 is provided and attached to one of the two opposed edges 221 or 221′ formed by the thickness of the top layers 22 of the coating 2 prior to assembly of the coating on the typographic plate cylinder 1.

The attachment may be obtained by gluing during the step of production of the coating or else subsequent thereto. Preferably, it is the edge of the gap filler that faces one of the opposed edges to be glued on the latter.

Said two opposed edges 221 and 221′ face one another, forming the aforesaid gap, when the coating is mounted and wound around the typographic plate cylinder. In particular, during assembly, the flaps 211 and 211′ of the hard layer 21 are bent and inserted in the groove or gap 11. Since said gap filler 23 is attached substantially to the edge 221, it remains suspended on the gap like an appendage, possibly jamming, with the face opposite to the one attached to the edge 221, against the edge 221′. In this way, the gap remains occluded by the gap filler 23 for at least one portion of its extension.

The gap filler 23 is preferably set on the trailing edge, but can also be located on the leading edge in rotation.

In this way, a coating thus obtained has a gap filler 23 attached to one of the edges 221 or 221′ of the coating, designed to occlude the gap when the coating is mounted on the typographic plate cylinder 1.

The cross section of said gap filler 23 is preferably rectangular, but may have various shapes.

Furthermore, said gap filler 23 may be formed of elastomeric material possibly containing appropriate cavities and/or microspheres.

The gap filler 23 can be obtained by extrusion or moulding and subsequent gluing of the element itself on one of the edges 221 or 221′ of the typographic coating. Alternatively, it can be obtained by direct deposition, on one of the edges 221 or 221′, of the material constituting the gap filler as if it were a sealant, possibly subsequently working on the contours to define the cross section better.

The advantage of the invention is that the gap is filled in a simple way, thus preventing accumulation of ink and paper dust within the gap, with all the problems that derive therefrom.

The particular modes of embodiment described herein do not limit the contents of this application, which covers all the variants of the invention defined by the claims.

1-20. (canceled)

21. A method for producing a coating for a typographic cylinder, said coating comprising a hard layer (21), deposited on which is at least one top layer (22), said at least one top layer (22) defining with its own thickness two opposed edges (221 and 221′) when the coating is mounted on the typographic cylinder (1), said method being characterized in that it comprises a step in which at least one elongated element (23) is prearranged and attached like an appendage to one of said opposed edges (221, 221′) for at least a portion of the length of the edge itself, and in that it comprises a further step of assembly of the coating (2) on the typographic cylinder (1) by bending the two flaps (211 and 211′) of the hard layer (21) corresponding to said opposed edges (221 and 221′) in order to insert them into a longitudinal groove (11) in the typographic cylinder (1), so that said elongated element (23) will close the space that is formed between said two flaps.

22. (canceled)

23. Method for producing a coating for a typographic cylinder according to claim 21, characterized in that said elongated element (23) is obtained by extrusion or moulding and subsequent gluing to said one of said opposed edges (221, 221′).

24. Method for producing a coating for a typographic cylinder according to claim 21, characterized in that said elongated element (23) is obtained by direct deposition of the material of which it is made on said one of said opposed edges (221, 221′) as if it were a sealant.

25. A coating for a typographic cylinder, characterized in that it comprises a hard layer (21), deposited on which is at least one top layer (22), said at least one top layer defining with its own thickness two opposed edges (221 to 221′) when the coating is mounted on the typographic cylinder (1), said coating comprising an elongated element (23) attached like an appendage to one of said opposed edges (221 and/or 221′) for at least a portion of the length of the edge itself, and in that said elongated element (23) has a cross section adapted for jamming between said opposed edges (221 and 221′) when the coating is mounted on the typographic cylinder (1).

26. (canceled)
